(19) United States
(12) Patent Application Publication
(10) Pub. No.: US 2025/0078311 A1
(43) Pub. Date: Mar. 6, 2025

(54) METHOD AND APPARATUS FOR ESTIMATING CAMERA POSE

(71) Applicants: Hyundai Motor Company, Seoul (KR); Kia corporation, Seoul (KR)

(72) Inventors: Jung Hyun Lee, Seoul (KR); Tae Hun Lim, Seoul (KR); Dong Hoon Koo, Seoul (KR); Young Hyun Kim, Seoul (KR)

(21) Appl. No.: 18/773,719

(22) Filed: Jul. 16, 2024

(30) Foreign Application Priority Data
Aug. 29, 2023 (KR) 10-2023-0114009

(51) Int. Cl. G06T 7/73; G06T 7/13

(52) U.S. Cl. CPC G06T 7/73; G06T 7/13; G06T 2207/20021; G06T 2207/20084; G06T 2207/30244

(57) ABSTRACT

Disclosed are a method and apparatus for estimating a camera pose. The method includes dividing an input image received from a camera into a plurality of regions, dividing the plurality of regions into a first detection zone for detecting a vanishing point or a roll and a second detection zone for detecting the roll, extracting a representative feature from features of the input image by using a filter generated in advance for each of the plurality of regions based on a design value of the camera, calculating a feature error of each of the first detection zone and the second detection zone based on the representative feature, and estimating a pose of the camera based on the feature error.

### CROSS-REFERENCE TO RELATED APPLICATION

This application claims the benefit of priority to Korean Patent Application No. 10-2023-0114009, filed in the Korean Intellectual Property Office on Aug. 29, 2023, the entire contents of which are incorporated herein by reference.

### TECHNICAL FIELD

The present disclosure relates to a technique for estimating a camera pose, and more specifically, to a method and apparatus for estimating a camera pose that can improve the estimation accuracy of the camera pose based on a vanishing point guide filter.

### BACKGROUND

Various image recognition technologies are required to operate autonomous vehicles. For example, identifying lanes while driving and identifying a vanishing point are also important factors.

A vanishing point refers to a point where parallel straight lines, which extend infinitely in three-dimensional space and are projected onto a two-dimensional plane, meet at one point on the plane. As an example of using vanishing point detection, a building may be reinterpreted by analyzing an artificial structure by finding vanishing points and vanishing lines in three mutually orthogonal directions. In 3D conversion of a 2D image containing an artificial structure, a depth map may be generated by detecting vanishing points. This is because as the 3D space changes to a 2D image, a part where the vanishing point is located generally corresponds to the furthest point in the image, so that it is possible to estimate the relative depth.

In addition, vanishing point information is an important basis for lane detection in an autonomous vehicle or location information analysis in an autonomous driving system such as a robot or the like. This is because roads can be detected by connecting major edges leading from a vanishing point.

While driving, the vehicle may estimate a vanishing point by using line segments in an image and estimate one vanishing line based on the estimated vanishing point, such that the extrinsic parameters of a camera and a road surface are estimated, thereby estimating the pose of the camera.

However, while the vehicle drives, vanishing point accuracy deteriorates due to image distortion, and it is difficult to estimate an accurate vanishing line due to the vanishing point bounding phenomenon due to vehicle behavior while driving.

### SUMMARY

The present disclosure has been made to solve the above-mentioned problems occurring in the prior art while improving camera pose estimation.

An aspect of the present disclosure provides a method for estimating a camera pose based on a vanishing point guide filter. A further aspect of the present disclosure relates to an apparatus capable of estimating the pose of a camera based on a vanishing point guide filter.

Another aspect of the present disclosure provides a method and apparatus capable of estimating a camera pose from an input image by using a vanishing point guide anchor and at least one pre-trained network.

Still another aspect of the present disclosure provides a method and apparatus capable of extracting representative features for each segmented region of an input image based on a vanishing point guide filter. After extracting the representative features, the method may estimate a camera pose by using the extracted representative features, thereby improving the accuracy of the camera pose estimation even while driving. Further, the apparatus may be capable of using the extracted representative features to estimate the camera pose.

Still another aspect of the present disclosure provides a method and apparatus capable of generating a vanishing point guide filter based on the design values of a camera mounted on a vehicle. Then, the method and apparatus may be capable of estimating the camera pose of a corresponding vehicle, such that the camera pose of the vehicle may be clearly estimated even when the design values of the camera attached to the vehicle are different.

The technical problems to be solved by the present disclosure are not limited to the aforementioned problems, and any other technical problems not mentioned herein will be clearly understood from the following description by those skilled in the art to which the present disclosure pertains.

A method may comprise: dividing, by a computing device and based on receiving an image from a camera, the image into a plurality of regions; dividing the plurality of regions into a first detection zone and a second detection zone, wherein the first detection zone is associated with a vanishing point and the second detection zone is associated with a roll; extracting, based on detecting one or more features of the image and using one or more filters for each of the plurality of regions, a representative feature of the image, wherein the one or more filters are based on a design value of the camera; determining, based on the representative feature, a first feature error in the first detection zone and a second feature error in the second detection zone; and estimating, based on the first feature error and the second feature error, a pose of the camera.

The dividing of the plurality of regions may comprise: dividing the plurality of regions into the first detection zone and the second detection zone based on the vanishing point, a vanishing line, and a preset vanishing line threshold value, wherein the vanishing point is based on the design value of the camera.

The extracting of the representative feature may comprise: extracting the representative feature from the one or more features of the image by applying one or more of: a first filter generated based on the vanishing point, wherein the vanishing point is associated with the design value of the camera, and a second filter generated based on a horizontal line for each of the plurality of regions.

The extracting of the representative feature may comprise: detecting, based on previously detected edges from the image and the one or more filters, the one or more features; and extracting, based on the one or more features and the design value of the camera, the representative feature.

The extracting of the representative feature may comprise: extracting, as the representative feature from the one or more features, a feature in which: a distance between vanishing points is less than or equal to a first value, wherein the vanishing points are associated with the design value of the camera; or an included angle with the roll is less than or equal to a second value, wherein the roll is associated with the design value of the camera.

The determining the first feature error may comprise: determining, as the first feature error, a distance between the representative feature and the vanishing point, wherein the vanishing point is associated with the design value of the camera, and wherein determining the second feature error comprises: determining, as the second feature error, an included angle between the representative feature and the roll, wherein the roll is associated with the design value of the camera.

The estimating of the pose of the camera comprises: estimating a position where the first feature error is minimized; and estimating an angle at which the second feature error is minimized.

The estimating of the pose of the camera comprises: estimating a position where the first feature error is minimized in the first detection zone as the vanishing point; and estimating an angle at which the second feature error is minimized in the second detection zone as the roll.

A method may comprise: dividing, by a computing device and based on receiving an image from a camera, the image into a plurality of regions; extracting, from edges of the image and based on an anchor filter, representative edges of the image, wherein the anchor filter is pre-generated by a first trained network and based on a design value of the camera; determining, based on a second trained network using the representative edges as input, a first feature error for estimating a vanishing point and a second feature error for estimating a roll; and based on the first feature error and the second feature error, generating a pose of the camera.

The second trained network may include a regression network.

The second trained network may automatically generate the pose of the camera based on the first feature error and the second feature error.

The method may further comprise: dividing, by the first trained network, the plurality of regions into a first detection zone and a second detection zone; and determining, by the first trained network, the edges of the image, wherein the edges of the image comprise edges of the plurality of regions located in the first detection zone and the second detection zone.

An apparatus may comprise: one or more processors; and memory storing instructions that, when executed by the one or more processors, cause the apparatus to perform one or more operations described herein.

A non-transitory computer-readable medium may store instructions that, when executed, cause performance of one or more operations described herein.

The features briefly summarized above with respect to the present disclosure are merely exemplary aspects of the detailed description of the present disclosure described below and do not limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 is a flowchart illustrating a method of estimating a camera pose according to an aspect of the present disclosure;

FIG. 2 is a diagram illustrating a scheme of dividing an input image;

FIG. 3 is a diagram illustrating a scheme of dividing a detection zone;

FIG. 4 is a flowchart illustrating an example of operation S140 of FIG. 1;

FIG. 5 is a diagram illustrating an example of a filter generated for each region;

FIG. 6 is a diagram illustrating an operation of extracting representative features from an input image;

FIG. 7 is a diagram illustrating a scheme of estimating a vanishing point of a camera;

FIG. 8 is a flowchart illustrating a method of estimating a camera pose according to another aspect of the present disclosure;

FIG. 9 is a diagram illustrating a method using a network;

FIG. 10 is a block diagram illustrating an apparatus for estimating a camera pose according to still another aspect of the present disclosure; and

FIG. 11 is a block diagram illustrating a computing system for executing a method of estimating a camera pose according to an aspect of the present disclosure.

### DETAILED DESCRIPTION

Hereinafter, various examples of the disclosure will be described in detail with reference to the accompanying drawings, so that those skilled in the art can easily carry out the disclosure. However, the disclosure is not limited to the examples set forth herein and may be modified variously in many different forms.

It will be understood that when an element is referred to as being “connected” or “coupled” to another element, it may be directly connected or indirectly connected to another element. In addition, when some part ‘includes’ or “has” some elements, unless explicitly described to the contrary, it means that other elements may be further included but not excluded.

Expressions such as “first,” or “second,” and the like, may express their elements regardless of their priority or importance and may be used to distinguish one element from another element but is not limited to these components. Therefore, without departing from the scope of the present disclosure, a first component of one example may be referred to as a second component of another example. Similarly, a second component of one example may be referred to as a first component of another example.

In the present disclosure, components that may be distinguished from each other for clearly describing characteristics, and may not mean that the components are necessarily separated. That is, a plurality of components may be integrated to form a single hardware or software unit, or a single component may be distributed to form a plurality of hardware or software units. Accordingly, such integrated or distributed examples are included in the scope of the present disclosure, even though not mentioned separately.

In the present disclosure, components described in various examples do not necessarily mean essential components, and some may be optional components. Therefore, an example composed of a subset of components described in an example is also included in the scope of the present disclosure. In addition, examples including other components in addition to the components described in various examples are also included in the scope of the present disclosure.

In the present disclosure, expressions of positional relationships used herein, such as upper, lower, left, right, and the like are described for convenience of description. When viewing the drawings shown in this specification in reverse, the positional relationship described in the specification may be interpreted in the opposite manner.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

An aspect of the present disclosure is to estimate a camera pose, for example, a vanishing point and roll of a camera, based on a design value of the camera and a vanishing point guide filter.

According to aspects of the present disclosure, a vanishing point guide filter may be generated based on the design value of a camera, and because the vanishing point guide filter is generated based on the design value, the estimation accuracy of the posture of the camera installed in a vehicle may be improved.

According to aspects of the present disclosure, by implementing an artificial intelligence network for extracting a representative feature based on a vanishing point guide filter from an input image and an artificial intelligence network for estimating a camera pose, for example, a vanishing point and a roll of the camera by using the representative feature as an input, it is possible to estimate the vanishing point and roll from the input image using at least one network. Of course, according to aspects of the present disclosure, without using two artificial intelligence networks, it is possible to apply an artificial intelligence network for extracting a representative feature or apply an artificial intelligence network for estimating the pose of a camera by using the representative feature.

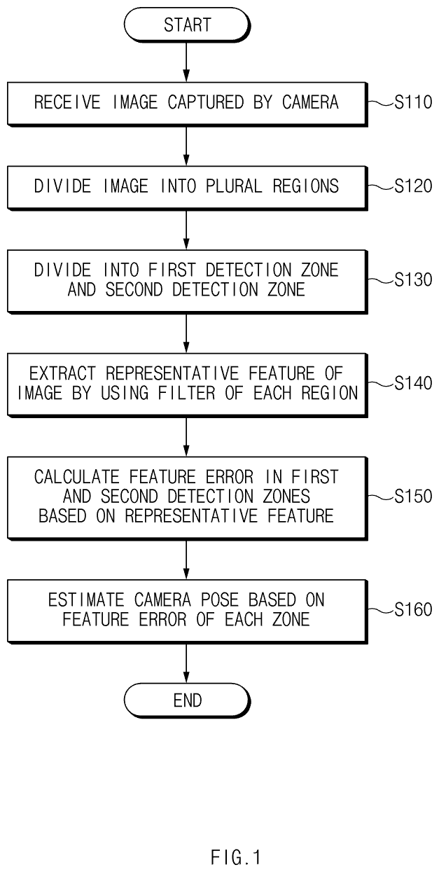

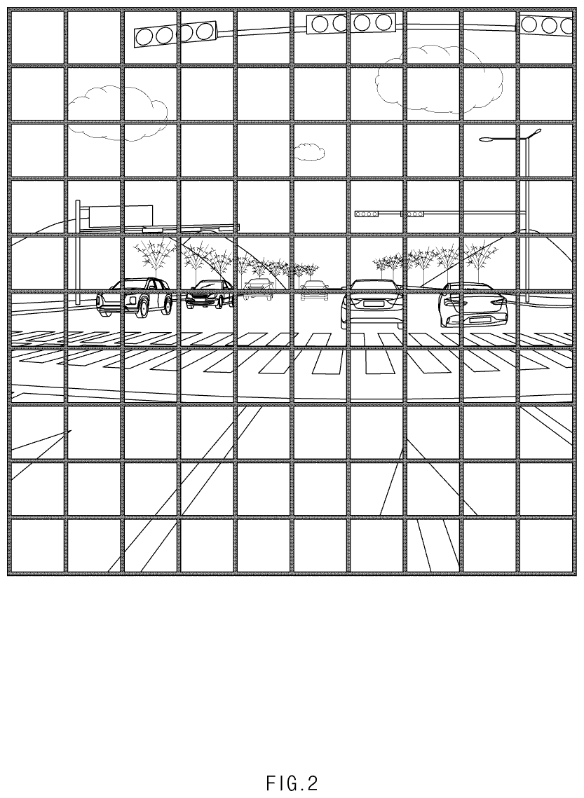

Hereinafter, a method and apparatus according to aspects of the present disclosure will be described with reference to FIGS. 1 to 10.

FIG. 1 is a flowchart illustrating a method of estimating a camera pose according to an aspect of the present disclosure, which illustrates an operation flow of an apparatus for estimating a camera pose provided in a vehicle.

Referring to FIG. 1, in S110 and S120, a method of estimating a camera pose according to an aspect of the present disclosure receives an image captured by a camera provided in a vehicle, for example, a travelling vehicle, and divides the received image, that is, the input image into a plurality of regions.

In this case, in S120, as shown in FIG. 120, the input image may be divided into a plurality of meshes, and the number of divided meshes may be determined depending on the number of filters generated based on the design value of the camera. The setting factor for dividing the number of meshes is not limited or restricted to the number of filters. The design value of the camera may include external parameters and internal parameters of the camera. The external parameter may indicate a relative position and direction between the camera and a photographing target. The internal parameters may include focal length, optical center, radial distortion coefficient, etc. of the lens system.

After the input image is divided into a plurality of meshes in operation S120, the plurality of meshes may be divided into a first detection zone for estimating the vanishing point or roll of the camera and a second detection zone for estimating the roll of the camera in S130.

According to an example, in operation S130, the plurality of meshes may be divided into the first detection zone and the second detection zone based on the vanishing point calculated with the design value of the camera, a vanishing line calculated with the design value of the camera, and a vanishing line threshold preset based on the vanishing line. The vanishing point may be determined using internal and external parameters based on a camera geometry.

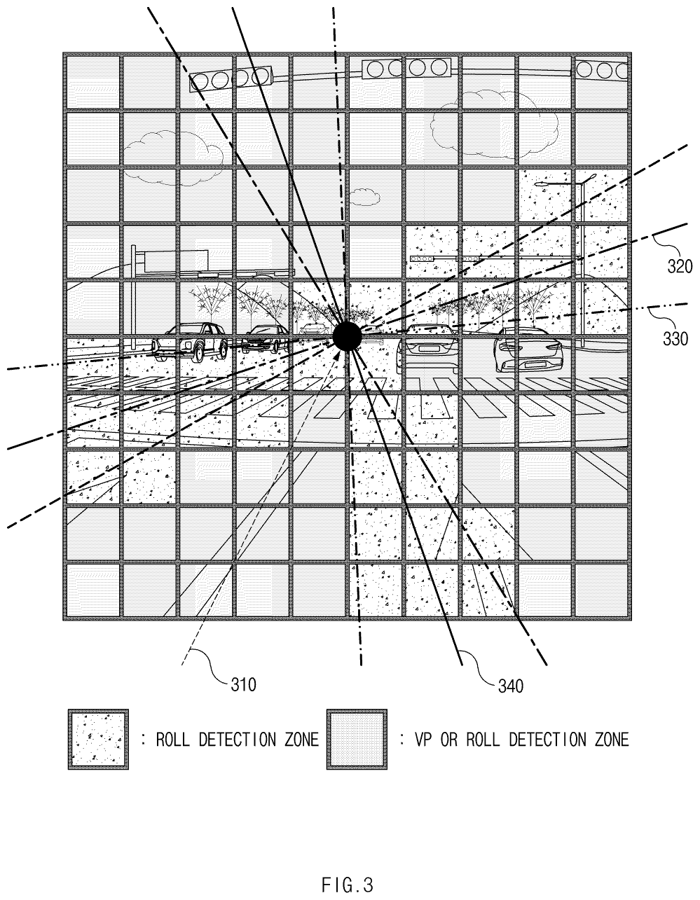

For example, as shown in FIG. 3, in operation S130, a vanishing line 320 calculated with the design value of the camera that passes through a vanishing point 310 calculated with the design value of the camera, a vanishing line 340 rotated by 90 degrees, and the meshes between two vanishing line threshold values 330 through the vanishing line threshold value 330 may be divided into the second detection zone, and the remaining meshes may be divided into the first detection zone. In FIG. 3, the meshes in an upper region among the meshes between the vanishing line 340 rotated by 90 degrees and the threshold value may be excluded from the second detection region for estimating the roll. This may be because a flow vector found at the vanishing point in a sky region of the image exists and there is no information to find the role.

After the first detection area for estimating the vanishing point or roll and the second detection area for estimating the roll are divided in operation S130, the representative feature of the input image may be extracted by using a filter generated in advance for each divided region, that is, each mesh in S140.

According to an example, in operation S140, the features corresponding to the filter, for example, edges (or straight lines) may be detected by using the edges detected for the input image and the filter of each mesh, and the representative feature for estimating the vanishing point and roll of the camera may be extracted based on the detected features and the design value of the camera, for example, the vanishing point and roll calculated using the design value of the camera.

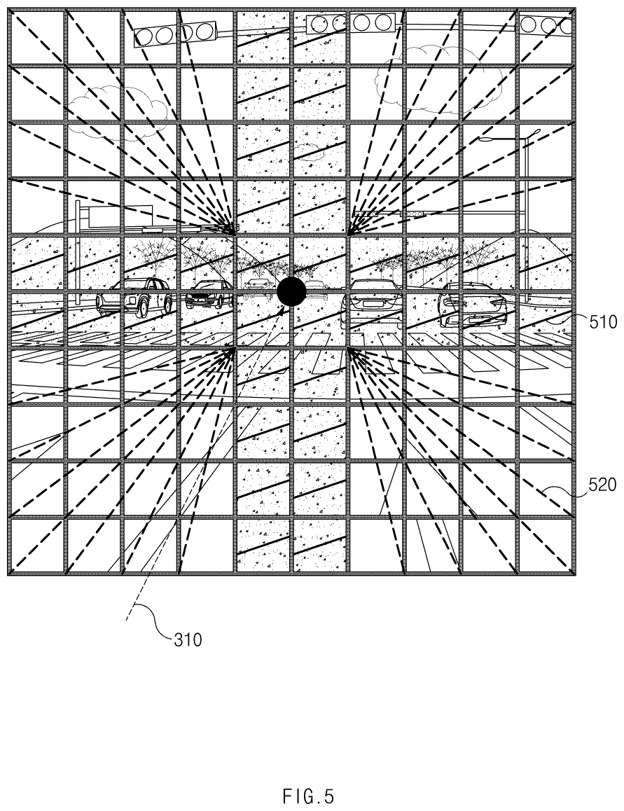

As shown in FIG. 5, the filter of each mesh applied in operation S140 may be one of a filter generated based on the vanishing point calculated with the design value of the camera and a filter generated based on a horizontal line. Describing FIG. 5 with an example, a filter 510 generated based on the horizontal line may be applied to each of the horizontal meshes and vertical meshes in a certain region based on the vanishing point 310 calculated with the design value, and a filter 520 generated based on the vanishing point may be applied to the remaining regions. Although the filter 520 generated based on the vanishing point in FIG. 5 includes a filter including a plurality of straight lines, this is for explaining that it may be a filter including a straight line passing through the vanishing point. In fact, the vanishing point-based filter may include one straight line passing through the center point of each mesh.

In other words, in operation S140, among the edges existing in each mesh, the edge corresponding to the filter of the mesh may be detected as features corresponding to the filter, and the representative feature may be extracted from the detected features.

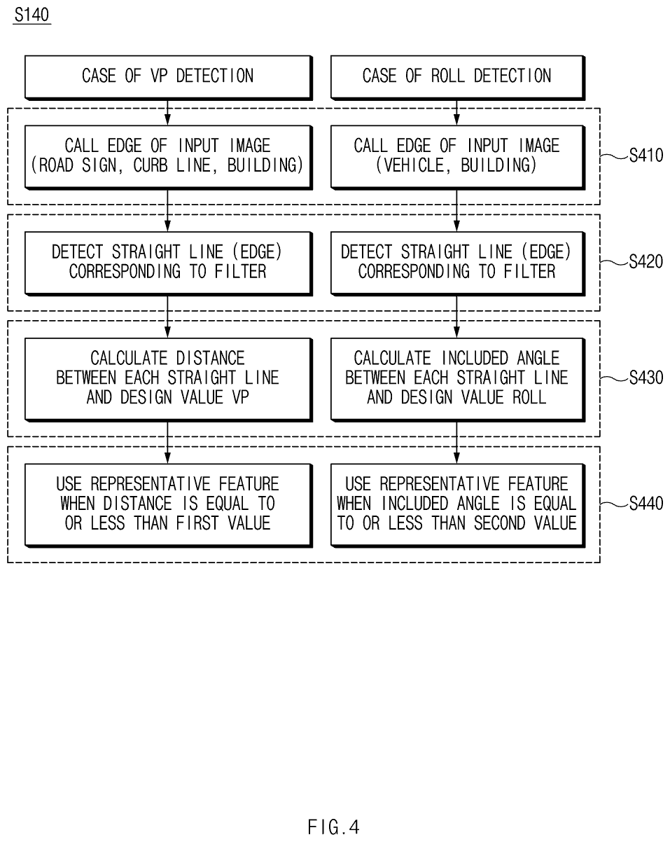

In detail, as shown in FIG. 4, operation S140 may include an operation of extracting the representative feature for a vanishing point VP detection or estimation and an operation of extracting a representative feature for roll detection or estimation. Each operation will be described sequentially below.

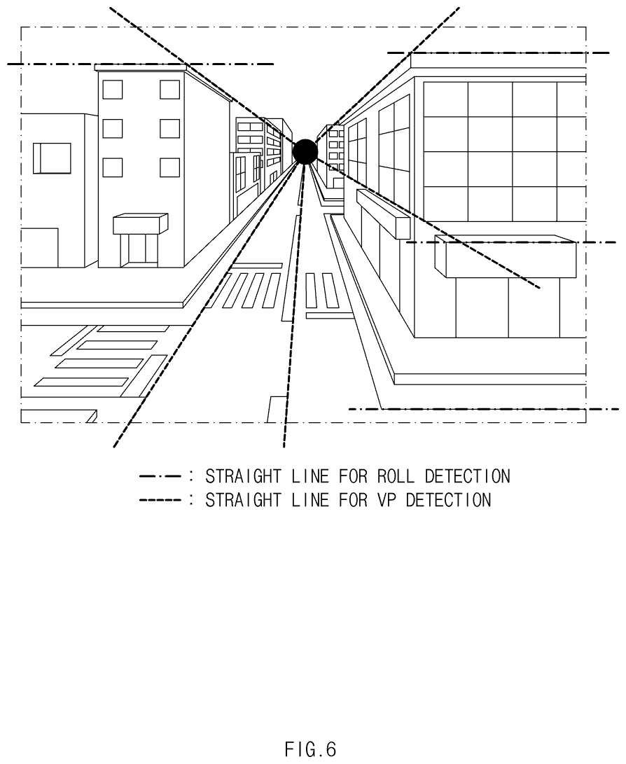

Describing an operation of extracting a representative feature for estimating a vanishing point, in S410 and S420, edges detected in an input image, such as road signs, curb lines, buildings, and the like may be called, and among the called edges, straight lines (edges), that is, features corresponding to the applied filter may be detected. For example, as shown in FIG. 6, a straight line for vanishing point VP detection may be detected by detecting the edge corresponding to the filter of each mesh in the edges called for the input image for vanishing point detection. In this case, the straight line for vanishing point detection in FIG. 6 may be the features detected by each filter.

In addition, in S430 and S440, the distance between each detected straight line and the vanishing point VP calculated with the design value may be calculated, and if the calculated distance is less than a preset first value, the corresponding feature may be used or extracted as the representative feature. In this case, the first value may be determined by an individual or business operator providing the technology of the present disclosure, and may be determined by considering the estimation accuracy of the vanishing point, and the like.

Similarly, describing an operation of extracting representative features for estimating roll, in S410 and S420, edges detected for the input image, for example, edges of a vehicle, a building, and the like may be called, and among the called edges, the straight lines (edges), that is, features, corresponding to the applied filter may be detected. For example, as shown in FIG. 6, a straight line for roll detection may be detected by detecting the edge corresponding to the filter of each mesh in the edges called for the input image for roll. In this case, the straight line for roll detection in FIG. 6 may be features detected by each filter.

In S430 and S440, if the included angle between each detected straight line and the roll calculated with the design value is calculated, and the calculated included angle is less than or equal to a preset second value, the corresponding feature may be used or extracted as a representative feature. In this case, the second value may be determined by an individual or business operator providing the technology of the present disclosure, and may be determined by considering the estimation accuracy of the roll, and the like.

In other words, a scheme according to an aspect of the present disclosure may not use all edges detected through a filter, but may use the vanishing point and roll calculated with the design value of the camera to extract a feature (representative feature) for estimating the vanishing point and roll, and through such an operation, the computational complexity of estimating the pose of the camera may be reduced.

Referring again to FIG. 1, after a straight line (or edge) corresponding to the representative feature for vanishing point detection and the representative feature for roll detection is detected through operation S140 described above, in S150 and S160, the feature error for each of the first detection zone and the second detection zone may be calculated based on the detected representative feature, and the pose of the camera, such as the vanishing point and roll, may be estimated based on the feature error of each detection zone.

In this case, the calculation of the feature error in each of the first detection zone and the second detection zone may refer to the calculation of the feature error in each detection zone based on the representative feature detected in the corresponding detection zone and the design value of the camera, and refer to the calculations of the feature error for vanishing point estimation and the feature error for roll estimation by using all representative features extracted in each detection zone.

According to an example, in operation S150, the distance between each detected representative feature (or straight line) and the vanishing point calculated with the design value of the camera may be calculated as the first feature error, and the included angle between each detected representative feature and the roll calculated with the design value of the camera may be calculated as the second feature error.

In this case, the first feature error and the second feature error may be expressed as following Equation 1 and Equation 2.

$$V P = ( {x}_{VP} , {y}_{V P} ) \qquad [ Equation l ]$$

$$\tilde{VP} = ( {x}_{VP} , {y}_{VP} , 1 )$$

$${L}_{n} = ( a , b ) ← s ( ax + b + 1 ) = 0$$

$${\tilde{L}}_{n} = ( a , b , 1 )$$

$$errV {P}_{n} = \frac{\vert \tilde{VP} \cdot {\tilde{L}}_{n} \vert}{‖ {L}_{n} ‖}$$

Where VP denotes vanishing point coordinates in an image, \tilde{V}P denotes vanishing point coordinates changed to the homogeneous coordinate system, Ln denotes a detected straight line equation including two parameters of a and b, \tilde{L}ₙ denotes a straight line equation changed to the homogeneous coordinate system, and errVPn denotes the first feature error.

$$θ = roll \qquad [ Equation 2 ]$$

$${R}_{n} = {slope}_{n}$$

$$err {θ}_{n} = \vert θ - {R}_{n} \vert$$

Where θ denotes a roll calculated with a design value, Rn denotes a tilt angle of a straight line detected as a representative feature, and errθₙ denotes the second feature error.

According to an aspect, in operation S160, if the first feature error and the second feature error for each straight line detected as a representative feature are calculated according to Equation 1 and Equation 2, the location at which the first feature error is minimized may be estimated as the vanishing point of the camera, and the angle at which the second feature error is minimized may be estimated as the roll of the camera.

In this case, the vanishing point and roll of the camera may be estimated by following Equation 3 and Equation 4.

$$\hat{VP} = {arg min}_{VP} {\sum }_{i = 1}^{n} {errVP}_{i} \qquad [ Equation 3 ]$$

$$\hat{θ} = {arg min}_{θ} {\sum }_{i = 1}^{n} err {θ}_{i} \qquad [ Equation 4 ]$$

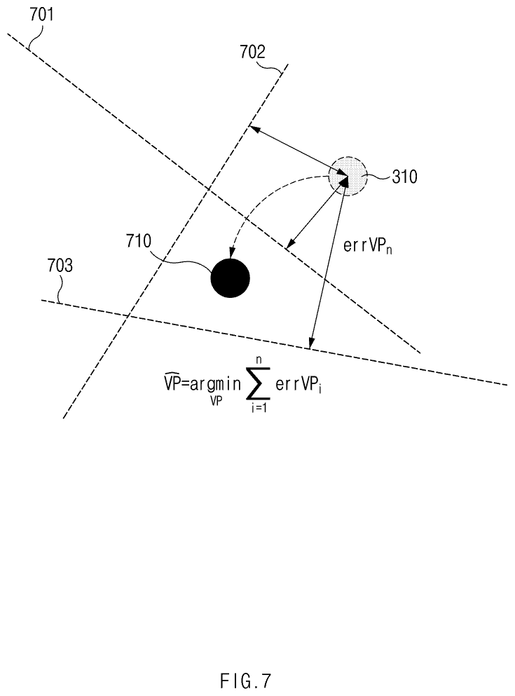

For example, describing a process of estimating a vanishing point of a camera with reference to FIG. 7, the first feature error errVPn may be calculated based on the distance between the vanishing point 310 of a camera calculated with the design value and each of straight lines 701, 702 and 703 detected for vanishing point detection and a location 710 of the vanishing point where the first feature error is minimized may be estimated as the vanishing point of the camera. Although FIG. 7 shows that there are three straight lines 701, 702 and 703 for vanishing point detection, the number of straight lines for vanishing point detection is not limited or restricted to three, and all straight lines detected through the process of FIG. 4 may be included. Therefore, it is possible to estimate the location of the vanishing point where the first feature error is minimized by using all straight lines detected in FIG. 4 as the vanishing point of the camera. Similarly, by the scheme of estimating the roll of the camera, it is possible to estimate, as the roll of the camera, the roll of the camera calculated based on the design value similarly to that of FIG. 7, and the angle at which the included angle between the tilt angles of straight lines detected for roll detection is minimized.

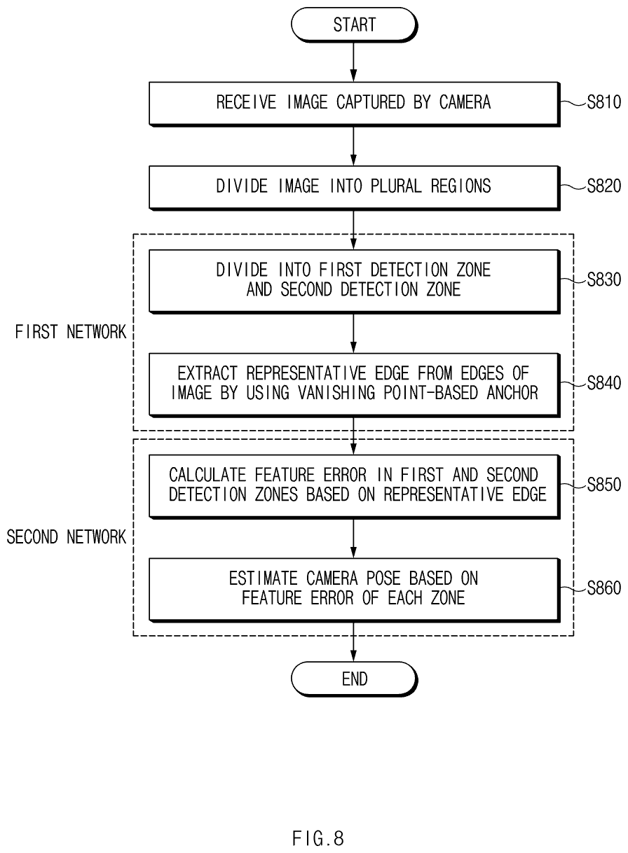

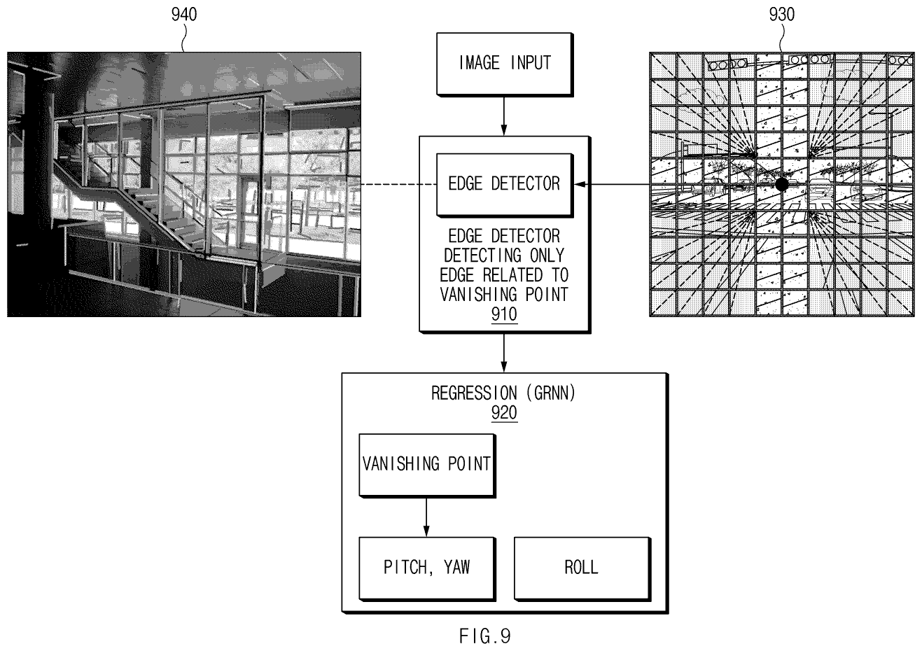

Furthermore, a method of estimating a camera pose according to an aspect of the present disclosure may be implemented through an artificial intelligence network. Hereinafter, a method of estimating a camera pose using an artificial intelligence network will be described with reference to FIGS. 8 and 9.

FIG. 8 is a flowchart illustrating a method of estimating a camera pose according to another aspect of the present disclosure, which illustrates an operation flow of estimating a camera pose using a first network and a second network.

Referring to FIG. 8, in S810 and S820, a method of estimating a camera pose according to another example of the present disclosure receives an image captured by a camera provided in a travelling vehicle, and divides the received image, that is, the input image into a plurality of regions.

After the input image is divided into a plurality of meshes in operation S820, in S830 and S840, the divided regions may be divided into a first detection zone for estimating a vanishing point or roll and a second detection zone for estimating a roll of a camera by using a pre-trained first network, for example, an artificial intelligence network for edge detection, and representative edges may be extracted from edges of the input image by using a pre-generated vanishing point-based anchor (or anchor filter). In this case, representative edges may correspond to representative features described in FIGS. 1 to 7.

According to an example, the first network may be a network that detects the edges of the input image based on an anchor filter and an image as input, detects edges corresponding to the anchor filter through the detected edges and the anchor filter, and then, extracts a representative edge from the detected edges. In this case, the anchor filter may be a vanishing point-based anchor filter calculated based on the design value of the camera.

After the representative edges for the input image are extracted by the first network, in S850 and S860, a feature error for each of the first detection zone and the second detection zone may be calculated based on the representative edges by using a pre-trained second network, for example, an artificial intelligence network for estimating a camera pose, and the pose of the camera, such as the vanishing point and roll, may be estimated based on the feature error of each detection zone.

Although the operations of the first network and the second network are described in detail with reference to FIG. 8, the method according to another example of the present disclosure may clearly extract the pose of the camera by using two networks, as it automatically extracts the representative features of the input image by using a plurality of regions divided from the first network and an anchor filter as input, and automatically extracts the pose of the camera by using representative features automatically extracted from the second network as input. Of course, each of the first network and the second network may be trained in advance based on training data for training each network.

In addition, although FIG. 8 illustrates the operation of dividing a detection zone that may be performed by the first network, the operation of dividing a detection zone may be performed through image analysis and the like, and the operation of extracting representative edges using information about the input image and the detection zone and an anchor filter may be performed in the first network.

In addition, the second network may automatically extract the vanishing point and roll of the camera by using the design value of the camera as input as well as information about representative edges of the input image, which may be the output of the first network. In this case, the second network may include a regression network such as a general regression neural network (GRNN).

Furthermore, as shown in FIG. 9, the first network used in a scheme according to another example of the present disclosure may be an edge detector 910 that detects edges related to the vanishing point in the input image, and the second network may be a recurrent network 920 such as a GRNN.

In this case, as shown in FIG. 9, the edge detection network 910 may detect an edge related to a vanishing point based on an input image, information 940 about edges detected in the input image, and an anchor filter 930 generated in advance based on the vanishing point and provide the detected edge to the second network 920. In addition, the regression network 920 may estimate the vanishing point of the camera by using the output of the first network 910, that is, edges corresponding to the vanishing point, and, if necessary, the design value of the camera as input, thereby estimating the pitch and yaw of the camera and the roll of the camera.

As described above, a method according to aspects of the present disclosure may estimate the pose of the camera based on a vanishing point guide filter or estimate the pose of the camera from an input image by using a vanishing point guide anchor (or anchor filter) and at least one pre-trained network.

In addition, a method according to examples of the present disclosure may extract representative features (or straight lines and edges) for each segmented region of the input image based on the vanishing point guide filter, and use the extracted representative features to estimate the camera pose, thereby improving the camera's posture estimation accuracy even while driving.

In addition, a method according to examples of the present disclosure may generate the vanishing point guide filter based on the design value of the camera mounted on a vehicle and estimate the camera posture of the corresponding vehicle, so that it is possible to clearly estimate the camera pose of the corresponding vehicle even though the design value of the camera attached to the vehicle is different.

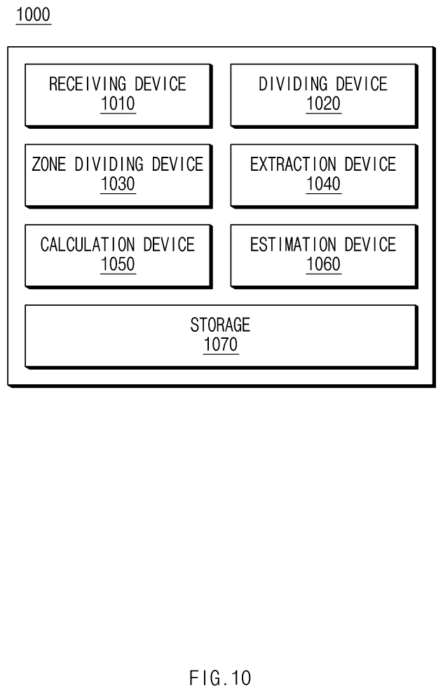

FIG. 10 is a block diagram illustrating an apparatus for estimating a camera pose estimation device according to still another aspect of the present disclosure, and illustrates an apparatus that performs schemes illustrated in FIGS. 1 to 9.

Referring to FIG. 10, an apparatus 1000 for estimating a camera pose according to still another aspect of the present disclosure may include a receiving device 1010, a dividing device 1020, a zone dividing device 1030, an extraction device 1040, a calculation device 1050, an estimation device 1060, and storage 1070.

The storage 1070, which may be a configuration element for storing all data related to the apparatus of the present disclosure, may store all data on the technology of the present disclosure, such as camera design values, filter information, received input images, algorithms for providing a detection zone, a scheme of calculating a distance between a straight line and a vanishing point, a scheme of calculating an included angle between the slope of a straight line and a roll, edge information extracted from an image, and estimated camera posture information.

The receiving device 1010 may receive an image captured by a vehicle camera. That is, the receiving device may receive an input image for estimating the pose of the camera from the camera.

In this case, the receiving device 1010 may perform preprocessing on the input image and then receive the preprocessed input image.

The dividing device 1020 may divide the input image received by the receiving device 1010 into a plurality of regions or meshes.

The zone dividing device 1030 may divide the regions divided by the dividing device 1020 into the first detection zone for detecting a vanishing point or a roll and the second detection zone for detecting a roll.

According to an example, the zone dividing device 1030 may classify the divided regions into the first detection zone and the second detection zone based on the vanishing point calculated with the design value of the camera and a preset vanishing line threshold value.

The extraction device 1040 may extract a representative feature from the features of the input image by using a filter generated in advance for each region based on the design value of the camera.

According to an example, the extraction device 1040 may apply one of a vanishing point-based filter and a horizon-based filter calculated with the design value of the camera for each of the divided regions to extract the representative feature from the features of the input image.

According to an example, the extraction device 1040 may detect the features corresponding to the filter by using the edges detected for the input image and a filter, and may extract the representative feature for estimating the vanishing point and roll of the camera based on the detected features and the design value of the camera.

According to an example, the extraction device 1040 may extract, as the representative feature, a feature from the features in which the distance between the vanishing points calculated with the design value of the camera is less than or equal to the first value or the included angle with the roll calculated with the design value of the camera is less than or equal to the second value.

The calculation device 1050 may calculate feature errors in each of the first detection zone and the second detection zone based on the representative feature of the input image extracted by the extraction device 1040.

According to an example, the calculation device 1050 may calculate the distance between each representative feature extracted by the extraction device 1040 and the vanishing point may be calculated with the design value of the camera as a first feature error, and may calculate the included angle between each representative feature and the roll calculated with the design value of the camera as the second feature error.

The estimation device 1060 may estimate the pose of the camera based on the feature error calculated by the calculation device 1050, such as the first feature error for vanishing point estimation and the second feature error for roll estimation.

According to an example, the estimation device 1060 may estimate the location at which the first feature error is minimized as the vanishing point of the camera and may estimate the angle at which the second feature error is minimized as the roll of the camera.

According to an example, the estimation device 1060 may estimate the location at which the feature error is minimized in the first detection zone as the vanishing point of the camera, and may estimate the angle at which the feature error is minimized in the second detection zone as the roll of the camera.

The apparatus according to another example of the present disclosure may include all contents described in the schemes of FIGS. 1 to 10.

According to an aspect of the present disclosure, a method of estimating a camera pose includes dividing an input image received from a camera into a plurality of regions, dividing the plurality of regions into a first detection zone for detecting a vanishing point or a roll and a second detection zone for detecting the roll, extracting a representative feature from features of the input image by using a filter generated in advance for each of the plurality of regions based on a design value of the camera, calculating a feature error of each of the first detection zone and the second detection zone based on the representative feature, and estimating a pose of the camera based on the feature error.

According to an example, the dividing of the plurality of regions may include dividing the plurality of regions into the first detection zone and the second detection zone based on a vanishing point calculated from the design value of the camera, a vanishing line and a preset vanishing line threshold value.

According to an example, the extracting of the representative feature may include extracting the representative feature from the features of the input image by applying one of a filter generated based on the vanishing point calculated with the design value of the camera and a filter generated based on a horizontal line for each of the plurality of regions.

According to an example, the extracting of the representative feature may include detecting the features by using edges detected for the input image and the filter, and extracting the representative feature based on the features and the design value of the camera.

According to an example, the extracting of the representative feature may include extracting, from the features, a feature in which a distance between vanishing points calculated by using the design value of the camera is less than or equal to a first value or an included angle with a roll calculated based on the design value of the camera is less than or equal to a second value as the representative feature.

According to an example, the calculating of the feature error may include calculating a distance between each representative feature and a vanishing point calculated based on the design value of the camera as a first feature error, and calculating an included angle between each representative feature and a roll calculated based on the design value of the camera as a second feature error.

According to an example, the estimating of the pose of the camera may include estimating a position where the first feature error is minimized as the vanishing point of the camera, and estimating an angle at which the second feature error is minimized as the roll of the camera.

According to an example, the estimating of the pose of the camera may include estimating a position where the feature error is minimized in the first detection zone as the vanishing point of the camera, and estimating an angle at which the feature error is minimized in the second detection zone as the roll of the camera.

According to another aspect of the present disclosure, a method of estimating a camera pose includes dividing an input image received from a camera into a plurality of regions, extracting representative edges from edges of the input image by using an anchor filter generated in advance based on a pre-learned first network and a design value of the camera, and calculating a first feature error for estimating a vanishing point and a second feature error for estimating a roll by using a pre-trained second network into which the representative edges are input, and estimating a pose of the camera based on the first feature error and the second feature error.

According to an aspect of the present disclosure, the second network may include a regression network.

According to still another aspect of the present disclosure, an apparatus for estimating a camera pose includes an image dividing device configured to divide an input image received from a camera into a plurality of regions, a zone dividing device configured to divide the plurality of regions into a first detection zone for detecting a vanishing point or a roll and a second detection zone for detecting the roll, an extraction device configured to extract a representative feature from features of the input image by using a filter generated in advance for each of the plurality of regions based on a design value of the camera, a calculation device configured to calculate a feature error in each of the first detection zone and the second detection zone based on the representative feature, and an estimation device configured to estimate the pose of the camera based on the feature error.

According to an aspect of the disclosure, the zone dividing device may divide the plurality of regions into the first detection zone and the second detection zone based on a vanishing point calculated from the design value of the camera, a vanishing line and a preset vanishing line threshold value.

According to an aspect of the disclosure, the extraction device may extract the representative feature from the features of the input image by applying one of a filter generated based on a vanishing point calculated with the design value of the camera and a filter generated based on a horizontal line for each of the plurality of regions.

According to an aspect of the disclosure, the extraction device may detect the features by using edges detected for the input image and the filter, and extract the representative feature based on the features and the design value of the camera.

According to an aspect of the disclosure, the extraction device may extract, from the features, a feature in which a distance between vanishing points calculated by using the design value of the camera is less than or equal to a first value or an included angle with a roll calculated based on the design value of the camera is less than or equal to a second value as the representative feature.

According to an aspect of the disclosure, the calculation device may calculate a distance between each representative feature and a vanishing point calculated based on the design value of the camera as a first feature error, and calculate an included angle between each representative feature and a roll calculated based on the design value of the camera as a second feature error.

According to an aspect of the disclosure, the estimation device may estimate a position where the first feature error is minimized as the vanishing point of the camera, and estimate an angle at which the second feature error is minimized as the roll of the camera.

According to an aspect of the disclosure, the estimation device may estimate a position where the feature error is minimized in the first detection zone as the vanishing point of the camera, and estimate an angle at which the feature error is minimized in the second detection zone as the roll of the camera.

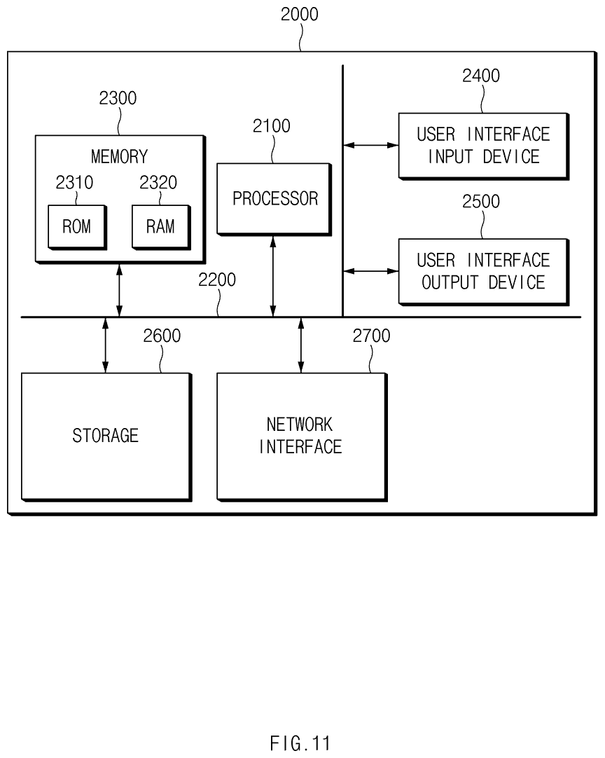

FIG. 11 is a block diagram illustrating a computing system for executing a method of estimating a camera pose according to an aspect of the present disclosure.

Referring to FIG. 11, as described above, the method of estimating a camera pose according to an example of the present disclosure may be implemented through a computing system. A computing system 2000 may include at least one processor 2100, a memory 2300, a user interface input device 2400, a user interface output device 2500, storage 2600, and a network interface 2700 connected through a system bus 2200.

The processor 2100 may be a central processing unit (CPU) or a semiconductor device that processes instructions stored in the memory 2300 and/or the storage 2600. The memory 2300 and the storage 2600 may include various volatile or nonvolatile storage media. For example, the memory 2300 may include a read only memory (ROM) 2310 and a random access memory (RAM) 2320.

Accordingly, the processes of the method or algorithm described in relation to the examples of the present disclosure may be implemented directly by hardware executed by the processor 2100, a software module, or a combination thereof. The software module may reside in a storage medium (that is, the memory 2300 and/or the storage 2600), such as a RAM memory, a flash memory, a ROM memory, an EPROM memory, an EEPROM memory, a register, a hard disk, a detachable disk, or a CD-ROM. The exemplary storage medium may be coupled to the processor 2100, and the processor 2100 may read information from the storage medium and may write information in the storage medium. In another method, the storage medium may be integrated with the processor 2100. The processor 2100 and the storage medium may reside in an application specific integrated circuit (ASIC). The ASIC may reside in a user terminal. In another method, the processor 2100 and the storage medium may reside in the user terminal as an individual component.

According to the present disclosure, it is possible to estimate the pose of the camera based on the vanishing point guide filter or estimate the pose of the camera from the input image by using the vanishing point guide anchor and at least one pre-trained network.

According to the present disclosure, it is possible to extract representative features for each segmented region of the input image based on the vanishing point guide filter, and use the extracted representative features to estimate the camera pose, thereby improving the posture estimation accuracy of the camera even while driving.

According to the present disclosure, it is possible to generate the vanishing point guide filter based on the design value of the camera mounted on a vehicle and estimate the camera pose of the corresponding vehicle, thereby clearly estimating the camera pose of the corresponding vehicle even though the design value of the camera attached to the vehicle may be different.

Effects obtained by various examples of the disclosure may not be limited to the above, and other effects will be clearly understandable to those having ordinary skill in the art from the following disclosures.

Although examples of the present disclosure have been described for illustrative purposes, those skilled in the art will appreciate that various modifications, additions and substitutions may be possible, without departing from the scope and spirit of the disclosure. Therefore, the examples disclosed in the present disclosure are provided for the sake of descriptions, not limiting the technical concepts of the present disclosure, and it should be understood that such examples are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A method comprising:
dividing, by a computing device and based on receiving an image from a camera, the image into a plurality of regions;
dividing the plurality of regions into a first detection zone and a second detection zone, wherein the first detection zone is associated with a vanishing point and the second detection zone is associated with a roll;
extracting, based on detecting one or more features of the image and using one or more filters for each of the plurality of regions, a representative feature of the image, wherein the one or more filters are based on a design value of the camera;
determining, based on the representative feature, a first feature error in the first detection zone and a second feature error in the second detection zone; and
estimating, based on the first feature error and the second feature error, a pose of the camera.

2. The method of claim 1, wherein the dividing of the plurality of regions comprises:
dividing the plurality of regions into the first detection zone and the second detection zone based on the vanishing point, a vanishing line, and a preset vanishing line threshold value, wherein the vanishing point is based on the design value of the camera.

3. The method of claim 1, wherein the extracting of the representative feature comprises:
extracting the representative feature from the one or more features of the image by applying one or more of:
a first filter generated based on the vanishing point, wherein the vanishing point is associated with the design value of the camera, and
a second filter generated based on a horizontal line for each of the plurality of regions.

4. The method of claim 1, wherein the extracting of the representative feature comprises:
detecting, based on previously detected edges from the image and the one or more filters, the one or more features; and
extracting, based on the one or more features and the design value of the camera, the representative feature.

5. The method of claim 4, wherein the extracting of the representative feature comprises:
extracting, as the representative feature from the one or more features, a feature in which:
a distance between vanishing points is less than or equal to a first value, wherein the vanishing points are associated with the design value of the camera; or
an included angle with the roll is less than or equal to a second value, wherein the roll is associated with the design value of the camera.

6. The method of claim 4, wherein the determining the first feature error comprises:
determining, as the first feature error, a distance between the representative feature and the vanishing point, wherein the vanishing point is associated with the design value of the camera, and
wherein determining the second feature error comprises: determining, as the second feature error, an included angle between the representative feature and the roll, wherein the roll is associated with the design value of the camera.

7. The method of claim 6, wherein the estimating of the pose of the camera comprises:
estimating a position where the first feature error is minimized; and
estimating an angle at which the second feature error is minimized.

8. The method of claim 1, wherein the estimating of the pose of the camera comprises:
estimating a position where the first feature error is minimized in the first detection zone as the vanishing point; and
estimating an angle at which the second feature error is minimized in the second detection zone as the roll.

9. A method comprising:
dividing, by a computing device and based on receiving an image from a camera, the image into a plurality of regions;
extracting, from edges of the image and based on an anchor filter, representative edges of the image, wherein the anchor filter is pre-generated by a first trained network and based on a design value of the camera;
determining, based on a second trained network using the representative edges as input, a first feature error for estimating a vanishing point and a second feature error for estimating a roll; and
based on the first feature error and the second feature error, generating a pose of the camera.

10. The method of claim 9, wherein the second trained network includes a regression network.

11. The method of claim 9, wherein the second trained network automatically generates the pose of the camera based on the first feature error and the second feature error.

12. The method of claim 9, further comprising:
dividing, by the first trained network, the plurality of regions into a first detection zone and a second detection zone; and
determining, by the first trained network, the edges of the image, wherein the edges of the image comprise edges of the plurality of regions located in the first detection zone and the second detection zone.

13. An apparatus comprising:
one or more processors; and
memory storing instructions that, when executed by the one or more processors, cause the apparatus to:
divide an image received from a camera into a plurality of regions;
divide the plurality of regions into a first detection zone associated with a vanishing point and a second detection zone associated with a roll;
extract, based on detecting one or more features of the image and using one or more filters for each of the plurality of regions, a representative feature of the image, wherein the one or more filters are based on a design value of the camera;
determine, based on the representative feature, a first feature error in the first detection zone and a second feature error in the second detection zone; and
estimate, based on the first feature error and the second feature error, a pose of the camera.

14. The apparatus of claim 13, wherein the instructions, when executed by the one or more processors, cause the apparatus to divide the plurality of regions into the first detection zone and the second detection zone based on the vanishing point, a vanishing line, and a preset vanishing line threshold value, wherein the vanishing point is based on the design value of the camera.

15. The apparatus of claim 13, wherein the instructions, when executed by the one or more processors, cause the apparatus to extract the representative feature from the one or more features of the image by applying one or more of:
a first filter generated based on the vanishing point, wherein the vanishing point is associated with the design value of the camera; or
a second filter generated based on a horizontal line for each of the plurality of regions.

16. The apparatus of claim 13, wherein the instructions, when executed by the one or more processors, cause the apparatus to:
detect, based on previously detected edges from the image and the one or more filters, the one or more features, and
extract, based on the one or more features and the design value of the camera, the representative feature.

17. The apparatus of claim 16, wherein the instructions, when executed by the one or more processors, cause the apparatus to extract, as the representative feature from the one or more features, a feature in which:
a distance between vanishing points is less than or equal to a first value, wherein the vanishing points are associated with the design value of the camera; or
an included angle with the roll is less than or equal to a second value, wherein the roll is associated with the design value of the camera.

18. The apparatus of claim 16, wherein the instructions, when executed by the one or more processors, cause the apparatus to:
determine, as the first feature error, a distance between the representative feature and the vanishing point, wherein the vanishing point is associated with the design value of the camera; and
determine, as the second feature error, an included angle between the representative feature and the roll, wherein the roll is associated with the design value of the camera.

19. The apparatus of claim 18, wherein the instructions, when executed by the one or more processors, cause the apparatus to:
estimate a position where the first feature error is minimized; and
estimate an angle at which the second feature error is minimized.

20. The apparatus of claim 13, wherein the instructions, when executed by the one or more processors, cause the apparatus to:
estimate a position where the first feature error is minimized in the first detection zone as the vanishing point; and
estimate an angle at which the second feature error is minimized in the second detection zone as the roll.
